(19) United States
(12) Patent Application Publication
(10) Pub. No.: US 2011/0052074 A1
(43) Pub. Date: Mar. 3, 2011

(54) IMAGE DATABASE CREATION DEVICE, IMAGE RETRIEVAL DEVICE, IMAGE DATABASE CREATION METHOD AND IMAGE RETRIEVAL METHOD

(75) Inventor: Ikuo Hayaishi, Dun Laoghaire (IE)

(73) Assignee: SEIKO EPSON CORPORATION, Shinjuku-ku (JP)

(21) Appl. No.: 12/872,947

(22) Filed: Aug. 31, 2010

(30) Foreign Application Priority Data
Aug. 31, 2009 (JP) 2009-200088

(51) Int. Cl. G06K 9/46

(52) U.S. Cl. 382/190; 382/305

(57) ABSTRACT

A device includes an image receiver which receives an image and a storage controller which stores the image in association with an identifier corresponding to a feature quantity of the image by using a previously prepared relationship between a feature quantity and an identifier.

Priority is claimed under 35 U.S.C. §119 to Japanese Application No. 2009-200088 filed on Aug. 31, 2009, which is hereby incorporated by reference in its entirety.

### BACKGROUND

1. Technical Field

The present invention relates to an image database creation technique and an image retrieval technique using a created image database.

2. Related Art

Techniques for retrieving a desired image via a network have been put into practical use. For example, an image database is proposed which stores images in association with additional information (character string information) such as titles and comments in order to realize the image retrieval using a keyword (character string). In the image retrieval using a keyword, it is required to suitably cope with notation fluctuation in order to improve retrieval accuracy since there are various image expressions and handling methods.

For the notation fluctuation problem, there is known a technique of executing the image retrieval by using a keyword, which is input in executing the retrieval, and synonyms thereof. In this technique, the synonym retrieval of an input retrieval word is executed and a retrieval query including the retrieval word and the retrieved synonyms is used to execute the image retrieval (see JP-A-2008-192110).

However, there is a problem in that when the retrieval is executed with the keyword and the synonyms thereof in performing the retrieval, a retrieval process is executed for each of the plural words and thus retrieval speed cannot be improved. In addition, in the past, individual keywords were assigned to images for each database. Accordingly, when the retrieval is executed by using the same keyword in different databases, the desired retrieval accuracy cannot be obtained in some cases.

These problems also occur in the retrieval of content such as videos, music, games and e-books, as well as in the retrieval of images.

### SUMMARY

The invention is contrived to solve at least a part of the problems and an advantage of some aspects of the invention is that an improvement in retrieval accuracy and an improvement in retrieval speed are achieved.

In order to solve at least a part of the problems, the invention adopts the following aspects.

A first aspect of the invention provides an image database creation device. The image database creation device includes an image acquisition section which acquires an image, a feature quantity extraction section which extracts a plurality of feature quantities characterizing the image from the acquired image, an identifier retrieval section which retrieves a corresponding identifier by using the extracted feature quantities from a feature quantity-identifier database in which feature quantity groups including a plurality of feature quantities characterizing an image and identifiers are associated in advance with each other and stored, and an image database establishment section which stores in an image database the acquired image in association with the retrieved identifier.

According to the image database creation device of the first aspect of the invention which includes the above configuration, since an image database can be created in which an image can be retrieved by using an identifier, image retrieval accuracy can be improved and image retrieval speed can be improved.

The image database creation device according to the first aspect of the invention further includes a keyword acquisition section which acquires a keyword relating to the acquired image. In the feature quantity-identifier database, the identifiers are further associated with a plurality of keywords, and when a keyword relating to the image is acquired, the identifier retrieval section may retrieve the identifier by using the acquired keyword. In this case, since an identifier can be decided by using a keyword relating to an image, an image database can be created in which the image retrieval using a keyword can be carried out.

In the image database creation device according to the first aspect of the invention, the acquired image is associated in advance with the keyword and the keyword acquisition section may acquire the previously associated keyword from the acquired image. In this case, since an image database can be created on the basis of a keyword which is associated in advance with an image, image retrieval accuracy using a keyword can be improved.

The image database creation device according to the first aspect of the invention further includes a keyword input section which is used to input a keyword and the keyword acquisition section may acquire a keyword which is input via the keyword input section. In this case, since an image database can be created on the basis of a keyword which is input via the keyword input section, an image database reflecting the feelings of a user can be created.

In the image database creation device according to the first aspect of the invention, the feature quantities include classes indicating kinds of feature quantities and numerical values indicating features of feature quantities in each class and the identifier retrieval section may retrieve the identifier corresponding to the extracted feature quantities by using numerical values of the feature quantities of the same class. By using plural classes of feature quantities, features of an image can be objectively quantified.

In the image database creation device according to the first aspect of the invention, the feature quantity-identifier database may include a dedicated identifier corresponding to a unique keyword. In this case, an image database can be created which can rapidly provide a retrieval result with high accuracy in the retrieval using a unique keyword.

In the image database creation device according to the first aspect of the invention, a plurality of the keywords which are stored in the feature quantity-identifier database may be hierarchized. In this case, keywords with plural concepts can be associated with an identifier and thus an image database can be created in which a decrease in retrieval accuracy occurring due to fluctuation of keywords can be suppressed.

In the image database creation device according to the first aspect of the invention, the image database establishment section may further associate and store a similarity degree of the acquired image with respect to the retrieved identifier. In this case, keyword likelihood of an identifier (keyword) which is used for an image obtained as a retrieval result can be shown.

A second aspect of the invention provides an image database creation method. The image database creation method according to the second aspect of the invention includes extracting a plurality of feature quantities characterizing an image from the acquired image, retrieving a corresponding identifier by using the extracted feature quantities from a feature quantity-identifier database in which feature quantity groups including a plurality of feature quantities characterizing an image and identifiers are associated in advance with each other and stored, and storing in an image database the acquired image in association with the retrieved identifier.

According to the image database creation method of the second aspect of the invention, the same actions and effects as in the case of the image database creation device according to the first aspect of the invention can be obtained and the method can be realized in various aspects as in the case of the image database creation device according to the first aspect of the invention.

The image database creation method according to the second aspect of the invention can be realized as an image database creation program and a computer-readable medium in which an image database creation program is recorded.

A third aspect of the invention provides an image retrieval device. The image retrieval device according to the third aspect of the invention includes a retrieval keyword acquisition section which acquires a retrieval keyword, an identifier retrieval section which retrieves a corresponding identifier by using the acquired keyword from a keyword-identifier database in which keyword and identifiers are associated with each other and stored, and an image retrieval section which retrieves a corresponding image by using the retrieved identifier from an image-identifier database in which images and identifiers are associated with each other and stored.

According to the image retrieval device of the third aspect of the invention, since an image can be retrieved by using an identifier which is retrieved on the basis of a keyword, image retrieval accuracy and image retrieval speed can be improved.

A fourth aspect of the invention provides an image retrieval method. The image retrieval method according to the fourth aspect of the invention includes acquiring a retrieval keyword, retrieving a corresponding identifier by using the acquired keyword from a keyword-identifier database in which keyword and identifiers are associated with each other and stored, and retrieving a corresponding image by using the retrieved identifier from an image-identifier database in which images and identifiers are associated with each other and stored.

According to the image retrieval method of the fourth aspect of the invention, the same actions and effects as in the case of the image retrieval device according to the third aspect of the invention can be obtained and the method can be realized in various aspects as in the case of the image retrieval device according to the third aspect of the invention.

The image retrieval method of the fourth aspect of the invention can be realized as an image retrieval program and a computer-readable medium in which an image retrieval program is recorded.

### BRIEF DESCRIPTION OF THE DRAWINGS

The invention will be described with reference to the accompanying drawings, wherein like numbers reference like elements.

FIG. 1 is an explanatory diagram illustrating the schematic configuration of an image retrieval system according to an embodiment of the invention.

FIG. 2 is an explanatory functional block diagram schematically illustrating the internal configuration of an image server according to the embodiment of the invention.

FIG. 3 is an explanatory diagram illustrating an example of an image database according to the embodiment of the invention.

FIG. 4 is an explanatory diagram illustrating an example of a keyword-identifier database according to the embodiment of the invention.

FIG. 5 is an explanatory diagram illustrating various programs and modules stored in a memory of the image server according to the embodiment of the invention.

FIG. 6 is an explanatory functional block diagram schematically illustrating the internal configuration of an image database creation device according to the embodiment of the invention.

FIG. 7 is an explanatory diagram illustrating an example of a feature quantity-identifier database according to the embodiment of the invention.

FIG. 8 is an explanatory diagram illustrating various programs and modules stored in a memory of the image database creation device according to the embodiment of the invention.

FIG. 9 is an explanatory functional block diagram schematically illustrating the internal configuration of a printer according to the embodiment of the invention.

FIG. 10 is an explanatory diagram illustrating various programs and modules stored in a memory of the printer according to the embodiment of the invention.

FIG. 11 is a flowchart illustrating a process routine of an identifier assignment process which is executed in the image database creation device according to the embodiment of the invention.

FIG. 12 is a flowchart illustrating a process routine of another identifier assignment process which is executed in the image database creation device according to the embodiment of the invention.

FIG. 13 is a flowchart illustrating a process routine of an image retrieval process which is executed in the image server according to the embodiment of the invention.

FIG. 14 is a flowchart illustrating a process routine of an image retrieval request process which is executed in the printer according to the embodiment of the invention.

FIG. 15 is an explanatory diagram illustrating an example of an image retrieval result screen which is displayed in the printer according to the embodiment of the invention.

### DESCRIPTION OF EXEMPLARY EMBODIMENTS

Hereinafter, an image retrieval system, an image server, an image database creation device, an image retrieval method, and a printer and a personal computer as an image retrieval terminal device according to the invention will be described on the basis of embodiments with reference to the accompanying drawings.

### First Embodiment

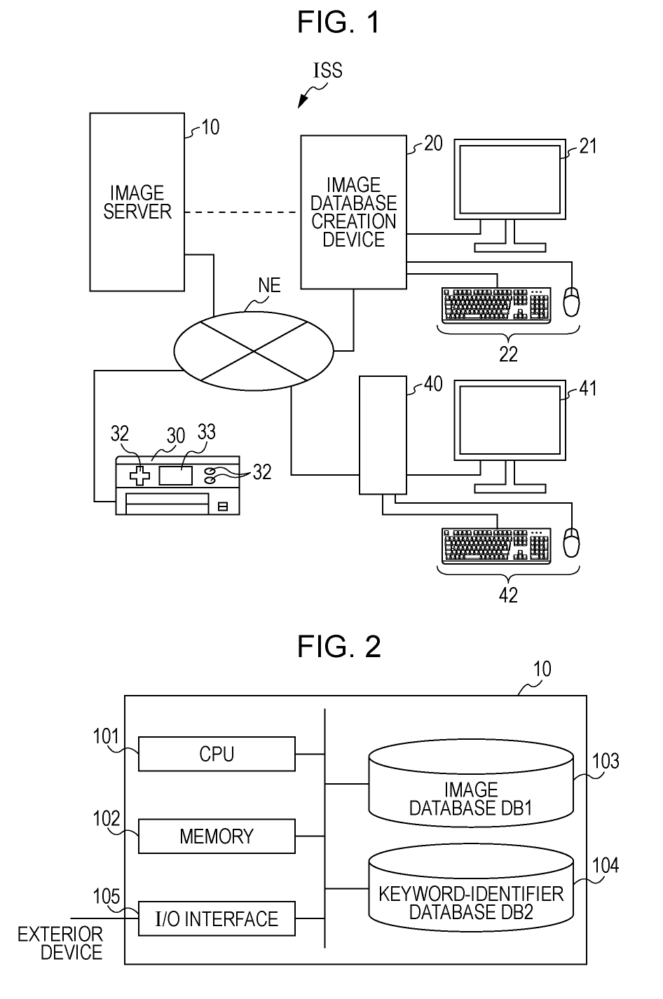

FIG. 1 is an explanatory diagram illustrating the schematic configuration of an image retrieval system according to this embodiment. An image retrieval system ISS according to this embodiment includes a server computer 10 as an image server, an image database creation device 20, a printer 30 and a personal computer 40. The server computer 10, the image database creation device 20, the printer 30 and the personal computer 40 are connected to each other via a network NE so as to carry out the two-way communication therebetween. The network may be an internet or an intranet. The image database creation device 20 may be locally connected (may be directly connected, not via the network) to the server computer 10.

The server computer 10 stores a plurality of image data to be retrieved, which are associated with identifiers, and executes the retrieval of images in response to a retrieval request from a client computer. Accordingly, it can be said that the server computer is an image server having an image database and an image retrieval device for retrieving image data. The printer 30 and the personal computer 40 can be referred to as clients with respect to the image server 10 or as image retrieval terminal devices. The personal computer 40 includes a display 41 and an input device 42 such as a keyboard and a mouse. The image database creation device 20 is an image database establishment device which creates a new image database on the server computer 10 or updates an existing image database on the server computer 10. The image database creation device 20 includes a display 21 and an input device 22 such as a keyboard and a mouse for inputting a keyword or the like.

### Configuration of Image Server:

FIG. 2 is an explanatory functional block diagram schematically illustrating the internal configuration of the image server according to this embodiment. The image server 10 includes a central processing unit (CPU) 101, a memory 102, a first storage device 103 in which an image database DB1 is established, a second storage device 104 in which a keyword-identifier database DB2 is established and an I/O interface 105. The CPU 101 executes various programs and modules which are stored in the memory 102. The memory 102 stores in a nonvolatile manner the programs and the modules, which are executed by the CPU 101, and has a work area in which the programs and the modules are developed in executing the process by the CPU 101. As the memory 102, for example, a read-only memory for storing programs and the like in a nonvolatile manner, a semiconductor storage device such as a random-access memory for providing a volatile work area in executing a program, a magnetic hard disk drive in which data can be recorded in a nonvolatile manner and a large-capacity flash memory can be used.

The first and second storage devices 103 and 104 are configured by at least one large-capacity storage device such as a hard disk drive and a flash memory drive. That is, both of the storage devices 103 and 104 may be realized by one large-capacity storage device which is logically divided into two storage devices, or may be two physically different storage devices. In the first storage device 103, the image database DB1 is established in which a plurality of image data are stored in association with unique identifiers. In the second storage device 104, the keyword-identifier database DB2 is established in which unique identifiers are stored in association with corresponding keyword groups. Herein, the “unique identifier” means that an identifier is unique with respect to a keyword group or image feature quantities. The identifier may be unique in each database unit or in a plurality of databases which are determined in advance as a retrieval target. An aspect of image data output (displayed, printed) on equipment is an image. However, it is obvious for a person skilled in the art that the image in the claims means image data.

In this embodiment, the database in which image data and identifiers are simply associated with each other and which is established in the first storage device 103 and the database in which keywords and identifiers are simply associated with each other and which is established in the second storage device 104 have been given as examples and described. However, both of the storage devices 103 and 104 may include a controller having a retrieval function so as to be an independent database system (file server) for outputting retrieval results in accordance with a retrieval request from the outside. In this case, the image database system is disposed outside the image server 10, and retrieval requests and retrieval results are transmitted and received between the image database system and the image server via the I/O interface 105. In addition, a program for receiving database retrieval requests and retrieval results is stored in the memory 102 and executed by the CPU 101. The association of image data with identifiers or the association of keywords with identifiers is realized by using a table showing the correspondence relationships between image data and identifiers and a table showing the correspondence relationships between keywords and identifiers. These tables may be included in both of the storage devices 103 and 104 or stored in the memory 102. In the former case, each of the storage devices 103 and 104 specifies an identifier or image data corresponding to a received keyword or identifier and reads the specified identifier or image data. In the latter case, each of the storage devices 103 and 104 reads an identifier or image data in accordance with a logic address received from the CPU 101.

The I/O interface 105 transmits and receives retrieval requests and retrieval results to and from exterior devices, for examples, clients such as the printer 30 and the personal computer 40, in accordance with a well-known communication protocol.

### Image Database:

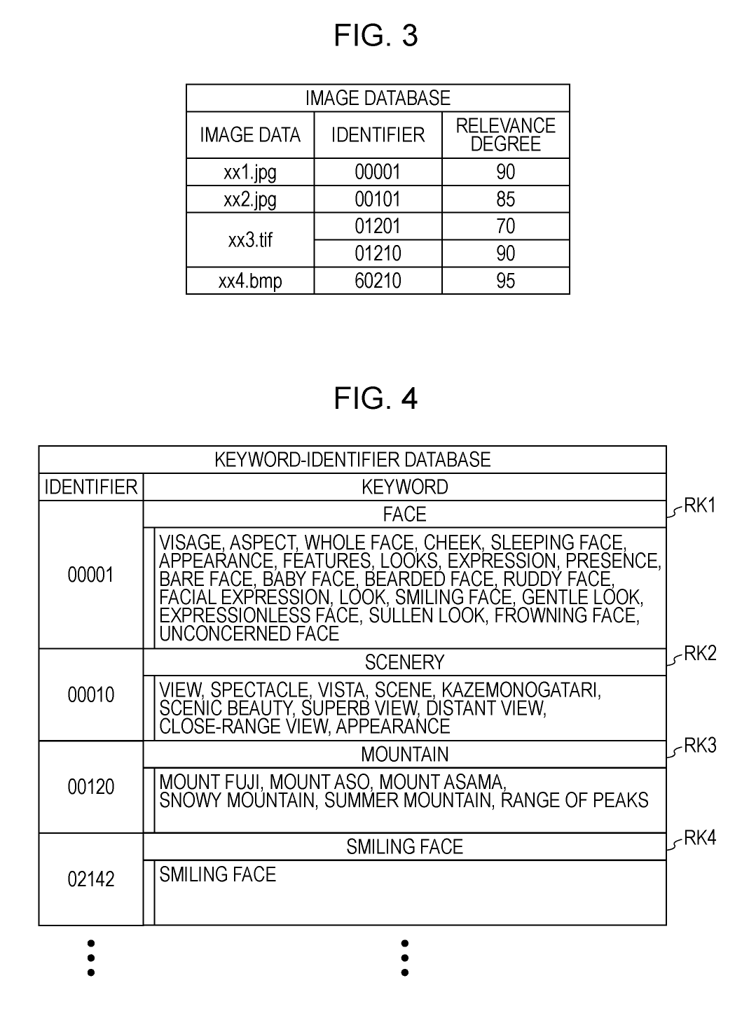

FIG. 3 is an explanatory diagram illustrating an example of the image database according to this embodiment. In this embodiment, image data, unique identifiers and relevance degrees are associated with each other and stored in the storage device 103. In this manner, the image database DB1 is established. Herein, the relevance degree is an index value for showing the strength of the association between an identifier or a keyword and image data, which is obtained on the basis of a similarity degree as described later. In this embodiment, by specifying an identifier, corresponding image data can be promptly retrieved, and determining a similarity degree by using a keyword or feature quantities of an image need not be carried out. Moreover, since similarity degrees of image data are associated in advance with identifiers, the similarity degrees can be obtained without the execution of a calculation process. As described above, the image database DB1 is realized by, for example, a management table in which image data, identifiers and similarity degrees are associated with each other. The similarity degrees may not be associated. Herein, the storage device 103 may include image data which are not added in the database by the image database creation device 20, and these image data are sequentially added to the image database DB1 by the image database creation device 20.

### Keyword-Identifier Database:

FIG. 4 is an explanatory diagram illustrating an example of the keyword-identifier database according to this embodiment. In this embodiment, keyword groups and unique identifiers are associated with each other and stored in the storage device 104. In this manner, the keyword-identifier database DB2 is established. The keyword to be associated with each identifier is decided on the basis of an empirical rule or a generalized broader concept of keywords. The keyword groups are hierarchized from representative keywords RK1 to RK4 of the keyword groups or broader concept keywords of the keyword groups to specific keywords. For example, in a face-related keyword group associated with an identifier 00001, a plurality of keywords including various face-related expression modes or expression levels, such as a “face” as the keyword RK1 representing the keyword group, a “smiling face” and a “frowning face” as specific facial expressions of the face and “features” and “appearance” as face-related expressions, are included. In addition, in a mountain-related keyword group associated with an identifier 00120, a plurality of keywords including various mountain-related expression modes or expression levels, such as a “mountain” as the keyword RK2 representing the keyword group, “Mount Fuji” and “Mount Aso” as specific mountain names, a “summer mountain” and a “snowy mountain” as mountain-related expressions and a “range of peaks” as a mountain-related keyword, are included. For the “smiling face” which is a high-frequency keyword as a face-related keyword, an individual keyword group may be provided. For example, in the example of FIG. 4, only one keyword “smiling face” belongs to a keyword group “smiling face” and a unique identifier 02142 is assigned thereto. In this case, with respect to a high-frequency keyword, an image corresponding to a desired keyword can be promptly retrieved.

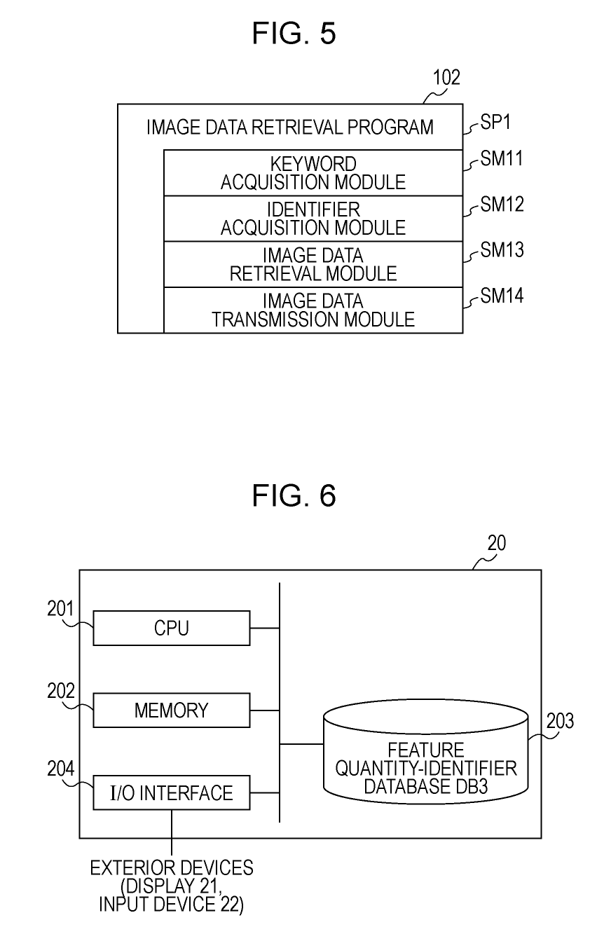

FIG. 5 is an explanatory diagram illustrating various programs and modules stored in the memory of the image server. Various programs and modules stored in the memory 102 will be described by using FIG. 5. The memory 102 stores an image retrieval program SP1 which is executed to retrieve an image from the image database according to this embodiment.

The image retrieval program SP1 includes a keyword acquisition module SM11, an identifier acquisition module SM12, an image data retrieval module SM13 and an image data transmission module SM14. The keyword acquisition module SM11 is executed to acquire a retrieval keyword which is transmitted by the printer 30 and the personal computer 40 as clients. The keyword acquisition module SM11 may have a function of receiving a noun, which is a word class, as a keyword or a function of receiving a keyword constituted by a plurality of word classes such as nouns and adjectives. In the former case, a received keyword can be promptly used in a subsequent process, and in the latter case, a morphological analysis may be carried out and then a process of leaving a space between words may be carried out to extract a noun and the extracted noun may be used as a keyword in a subsequent process. Herein, detailed descriptions of the techniques such as a morphological analysis and a process of leaving a space between words will be omitted because these are well-known techniques. The keyword acquisition module SM11 may extract and acquire a keyword from metadata which is associated with image data transmitted from the printer 30 and the like. The identifier acquisition module SM12 is executed to retrieve and acquire from the keyword-identifier database DB2 a corresponding identifier by using the keyword acquired by the keyword acquisition module SM11. Herein, in the keyword-identifier database DB2, keyword groups including a plurality of mutually related keywords are stored in association with identifiers. Accordingly, the identifier acquisition module SM12 can acquire a corresponding identifier by retrieving a keyword group including the acquired keyword.

The image data retrieval module SM13 retrieves and acquires corresponding image data by using the identifier acquired by the identifier acquisition module SM12 from the image database DB1. In greater detail, the image data retrieval module SM13 retrieves and acquires an identifier coincident with the acquired identifier from the image database DB1. Accordingly, in this embodiment, when desired image data is retrieved, the desired image data can be promptly retrieved without a process of calculating a similarity degree or the like. The image data transmission module SM14 transmits the image data obtained by the retrieval to the printer 30 and the personal computer 40 which are clients transmitting the retrieval keyword. The keyword acquisition module SM11, the identifier acquisition module SM12 and the image data retrieval module SM13 are executed by the CPU 101 to function as a retrieval keyword acquisition section, an identifier acquisition section and an image retrieval section, respectively. The keyword acquisition module SM11, the identifier acquisition module SM12 and the image data retrieval module SM13 may be realized by hardware. That is, these may be realized by semiconductor circuits.

### Configuration of Image Database Creation Device:

FIG. 6 is an explanatory functional block diagram schematically illustrating the internal configuration of the image database creation device according to this embodiment. The image database creation device 20 includes a central processing unit (CPU) 201, a memory 202, a storage device 203 in which a feature quantity-identifier database DB3 is established and an I/O interface 204. The CPU 201 executes various programs and modules which are stored in the memory 202. The memory 202 stores in a nonvolatile manner the programs and the modules, which are executed by the CPU 201, and has a work area in which the programs and the modules are developed in executing the process by the CPU 201. As the memory 202, for example, a read-only memory for storing programs and the like in a nonvolatile manner, a semiconductor storage device such as a random-access memory for providing a volatile work area in executing a program, a magnetic hard disk drive in which data can be recorded in a nonvolatile manner and a large-capacity flash memory can be used.

The storage device 203 is configured by at least one large-capacity storage device such as a hard disk drive and a large-capacity flash memory drive. In the storage device 203, the feature quantity-identifier database is established in which identifiers (ID), image feature quantity groups including feature quantities of a plurality of image data and keywords are associated with each other. An aspect of image data output (displayed, printed) on equipment is an image. However, it is obvious for a person skilled in the art that the image in the claims means image data.

The I/O interface 204 transmits and receives an input signal or an output signal to and from exterior devices, for examples, the display 21 and the input device 22.

### Feature Quantity-Identifier Database:

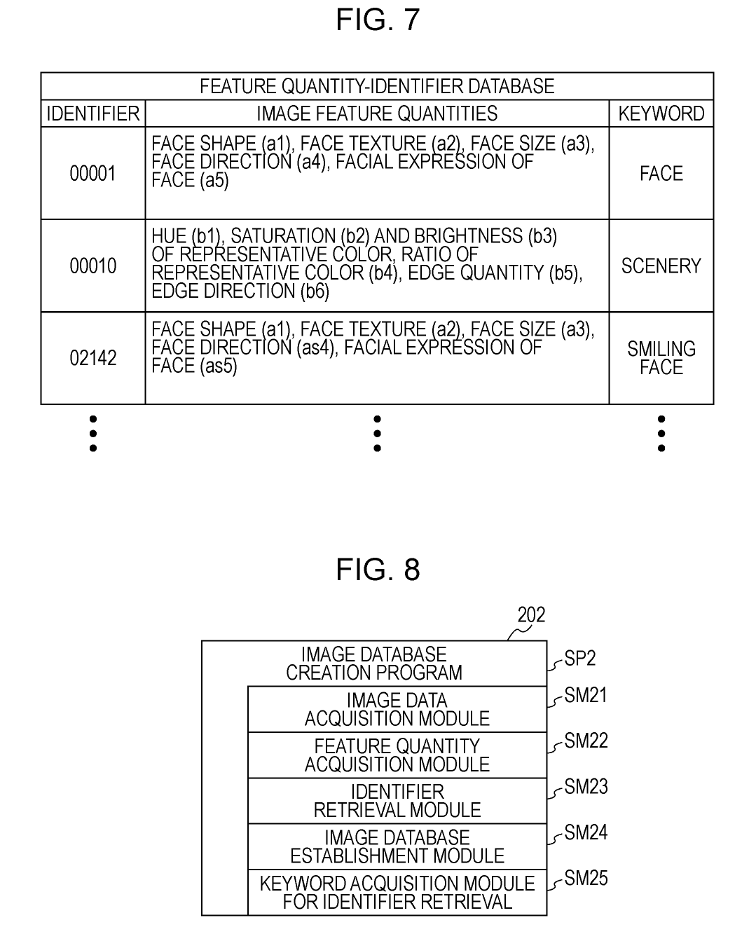

FIG. 7 is an explanatory diagram illustrating an example of the feature quantity-identifier database according to this embodiment. In this embodiment, as described above, a plurality of image feature quantities corresponding to one keyword group and a unique identifier are associated with each other and stored in the storage device 203. In this manner, the feature quantity-identifier database DB3 is established. The class and value of feature quantities to be associated with each identifier are decided on the basis of an empirical rule. In FIG. 7, for the sake of easier description, a representative keyword of a keyword group is exemplified in the keyword item. In practice, however, a keyword group including a plurality of keywords is associated as shown in FIG. 4. In the example of FIG. 7, for example, a face-related keyword group is associated with image feature quantities such as a face shape (a1), a face texture (a2), a face size (a3), a face direction (a4) and a facial expression of a face (a5). For the sake of easier understanding, the expressions such as face shape, face texture, face size, face direction and facial expression of a face are used. In practice, however, an average value of feature quantities such as a main subject shape, a main subject texture, a main subject size, a main subject direction and a main subject facial expression, which are used when the main subject is determined as a face, is associated.

The area of a main subject can be set by grouping adjacent pixels of which pixel values, for example, R, G and B component values approximate to each other, or adjacent pixels belonging to a predetermined hue (generally, skin color) range among pixels constituting an image. For example, in the case of face size, the width and the height of the area of a main subject which is properly considered as the face may be provided as image feature quantities, and in the case of face direction, a swing angle in a horizontal direction and a swing angle in a vertical direction of the area of the main subject may be provided as image feature quantities. In the case of face texture, a value of proper spatial frequencies for the face among spatial frequencies which are used in well-known texture extraction methods may be provided as an image feature quantity. In the cases of face shape and facial expression of a face, an average value of values which can be obtained as coordinate values of the outline of the area of the main subject (face) and organs such as eyes, a nose, a mouth and eyebrows in the face may be provided as an image feature quantity.

A scenery-related keyword group is associated with an average value of a hue of representative color of image (b1), a ratio of representative color of the image in the image (b4) and saturation (b2), brightness (b3), edge quantity (b5) and edge direction (b6) of the image. It is obvious for a person skilled in the art that these feature quantities are obtained by subjecting pixel data constituting image data to a statistical process, so a detailed description thereof will be omitted.

Regarding a smiling face-related keyword group, the same image feature quantities as in the face-related keyword group are provided in the cases of face shape (a1), face texture (a2) and face size (a3), and image feature quantities unique to the smiling face are provided in the cases of face direction (as4) and facial expression of a face (as5).

FIG. 8 is an explanatory diagram illustrating various programs and modules stored in the memory of the image database creation device according to this embodiment. The memory 202 stores an image database creation program SP2 which is executed to create an image database according to this embodiment. The image database creation program SP2 includes an image data acquisition module SM21, a feature quantity acquisition module SM22, an identifier retrieval module SM23, an image database establishment module SM24 and a keyword acquisition module SM25 for identifier retrieval.

The image data acquisition module SM21 acquires image data which is provided from an exterior storage device to the image database creation device 20 or image data which is stored in the storage device 103 of the image server 10 and does not yet belong to the image database DB1. That is, the image database creation device 20 according to this embodiment may be used to establish the image database DB1 according to this embodiment in the storage device in which an image database different from the image database DB1 according to this embodiment is established, to establish the image database DB1 by using image data stored in the storage device in which no image database is established, or to establish the image database DB1 while storing image data from the outside in the storage device in which no image data is stored.

The feature quantity acquisition module SM22 is executed to acquire feature quantities from the image data which is acquired by the image data acquisition module SM21. Herein, the feature quantities include classes such as average luminance, the maximum luminance and the minimum luminance of image data, a hue, saturation and brightness of representative color, a ratio of representative color in the image, a face shape included in the image data, a face size, a face texture, a face direction, a facial expression of a face, an edge quantity and a direction position of an edge, and values indicating whether the feature quantity is large or small or whether the feature quantity is high or low in each class. These classes of the feature quantities are well known to a person skilled in the art, and, as a method of calculating a value of each class (value of feature quantity), methods which are well known to a person skilled in the art can be used. The identifier retrieval module SM23 is executed to retrieve a coincident or approximate identifier from identifiers stored in the feature quantity-identifier database DB3 by using the feature quantities which are acquired by the feature quantity acquisition module SM22. In greater detail, similarity degrees between the acquired feature quantities and feature quantities corresponding to identifiers are respectively calculated so as to retrieve (specify) an identifier with a similarity degree which is equal to or greater than a predetermined level or an identifier with the highest similarity degree.

The image database establishment module SM24 establishes the image database DB1 by storing at least one identifier which is retrieved by the identifier retrieval module SM23 in association with the image data which is acquired by the image data acquisition module SM21 in the storage device 103. The keyword acquisition module SM25 for identifier retrieval is executed to acquire a keyword which is input by the input device 22 or a keyword which is associated in advance with the acquired image data. When a keyword is acquired by the keyword acquisition module SM25 for identifier retrieval, a process of retrieving (deciding) an identifier on the basis of the keyword prior to the feature quantities of the image data may be carried out. Herein, the above “prior to” means that an identifier retrieval process based on the feature quantities of the image data is not carried out, or that although the identifier retrieval process based on the feature quantities of the image data is carried out, an identifier corresponding to the acquired keyword is assigned as an identifier having the highest similarity degree. The image data acquisition module SM21, the feature quantity acquisition module SM22, the identifier retrieval module SM23, the image database establishment module SM24 and the keyword acquisition module SM25 for identifier retrieval are executed by the CPU 201 to function as a retrieval image acquisition section, a feature quantity acquisition section, an identifier retrieval section, an image database establishment section and a keyword acquisition section for identifier retrieval, respectively. The image database creation program SP2, the image data acquisition module SM21, the feature quantity acquisition module SM22, the identifier retrieval module SM23, the image database establishment module SM24 and the keyword acquisition module SM25 for identifier retrieval may be realized by hardware such as semiconductor circuits.

### Configuration of Printer:

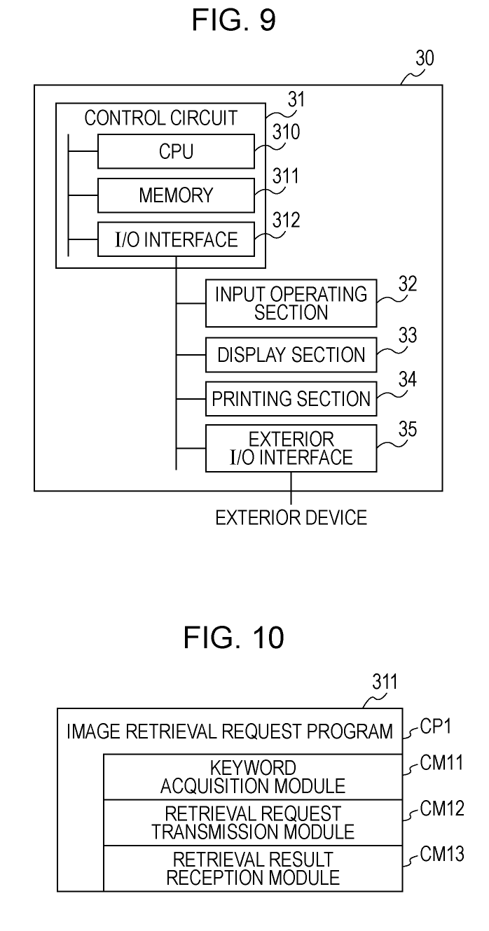

FIG. 9 is an explanatory functional block diagram schematically illustrating the internal configuration of the printer according to this embodiment. FIG. 10 is an explanatory diagram illustrating various programs and modules stored in a memory of the image printer. In this embodiment, the printer 30 is exemplified and described as an image retrieval terminal device, but it is obvious that the personal computer 40 can also be used as an image retrieval terminal device. The printer 30 includes a control circuit 31, an input operating section 32, a display section 33, a printing section 34 and an exterior I/O interface 35 which are connected to each other by a signal line. The control circuit 31 includes a central processing unit (CPU) 310, a memory 311 and an I/O interface 312 which are connected so as to communicate therewith. The CPU 310 executes various programs and modules which are stored in the memory 311. The memory 311 stores in a nonvolatile manner the programs and the modules, which are executed by the CPU 310, and has a nonvolatile work area in which the programs and the modules are developed in executing the process by the CPU 310. As the memory 311, for example, a read-only memory for storing programs and the like in a nonvolatile manner, a semiconductor storage device such as a random-access memory for providing a volatile work area in executing a program, a hard disk drive and a large-capacity flash memory can be used. The I/O interface 312 transmits and receives commands and data to and from the control circuit 31, the input operating section 32, the display section 33, the printing section 34 and the exterior I/O interface 35. The input operating section 32 is used to input an instruction to the printer 30 by a user and can be realized by, for example, a button or a wheel. The display section 33 is a display screen capable of color display on which an image based on the retrieved image data is displayed to a user and various pieces of information are displayed to the user. The printing section 34 is a printing execution section for forming an image on a printing medium in accordance with a printing instruction from a user (control circuit 31). The exterior I/O interface 35 transmits and receives retrieval requests and retrieval results to and from, for example, the image server 10 in accordance with a well-known communication protocol.

The various programs and modules which are stored in the memory 311 will be described by using FIG. 10. The memory 311 includes an image retrieval request program CP1 for requesting image retrieval to the image server 10. The image retrieval request program CP1 includes a keyword acquisition module CM11, a retrieval request transmission module CM12 and a retrieval result reception module CM13. The keyword acquisition module CM11 is executed to acquire a keyword which is input by a user in order to specify an image (image data) as a retrieval target. Regarding the acquisition of a keyword, a keyword input by the input operating section 32 may be acquired, or a keyword described in metadata which is associated in advance with image data may be extracted and acquired. Alternatively, both of a keyword input by the input operating section 32 and a keyword described in metadata of image data may be acquired. The retrieval request transmission module CM12 is used to transmit to the image server 10 the acquired keyword and a request for retrieval. The retrieval result reception module CM13 is used to acquire at least one image data as a retrieval result from the image server 10. The image retrieval request program CP1, the keyword acquisition module CM11, the retrieval request transmission module CM12 and the retrieval result reception module CM13 are executed by the CPU 310 to function as an image retrieval request section, a retrieval request keyword acquisition section, a retrieval request transmission section and a retrieval result reception section.

### Identifier Assignment Process:

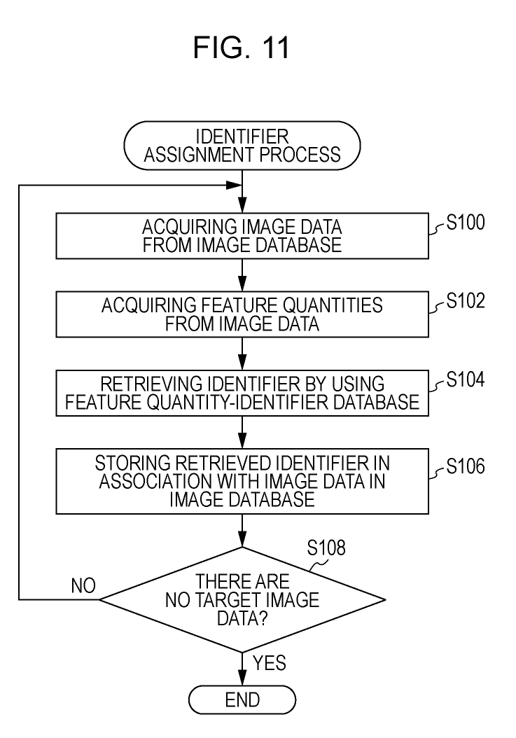

FIG. 11 is a flowchart illustrating a process routine of an identifier assignment process which is executed by the image database creation device according to this embodiment. When this process routine is started, the image data acquisition module SM21 acquires image data from the storage device 103 (Step S100). In greater detail, image data to which identifiers are not yet assigned are read from the storage device 103 of the image server 10 in arbitrary order or under a certain condition (for example, in chronological order of image data creation) and stored in the memory 202. As described above, the image data may belong to another image database which has already been established or may not belong to any image database (may be simply stored in the storage device 103). In addition, the image data acquisition module SM21 may acquire image data from another exterior storage device in place of the storage device 103.

The feature quantity acquisition module SM22 acquires feature quantities from the image data which are acquired by the image data acquisition module SM21 (Step S102). In greater detail, values of previously set plural kinds of feature quantities are obtained. The “previously set plural kinds” are kinds corresponding to the kinds of feature quantities which are stored as image feature quantities in the feature quantity-identifier database DB3. That is, in order to specify identifiers by effectively utilizing the feature quantity-identifier database DB3, it is desirable that the same kinds of feature quantities as the kinds of feature quantities included in the database are used to retrieve the identifiers.

In this embodiment, values of classes such as, as feature quantities, average luminance, the maximum luminance and the minimum luminance of image data, a hue, saturation and brightness of representative color, a ratio of representative color in the image, a face shape included in the image data, a face size, a face texture, a face direction, a facial expression of a face, an edge quantity and a direction position of an edge are obtained. When the image data is RGB dot matrix data, first, the feature quantity acquisition module SM22 obtains R, G and B component values of all the pixel data constituting the image data or pixel data (sampling pixel data) remaining after thinning of a predetermined quantity of the image data. A frequency distribution (histogram) of each component is obtained by plotting each of the obtained R, G and B component values on a graph with a horizontal axis for a value of each of the R, G and B component values (also referred to as a gradation value) and a vertical axis for appearance frequency. In order to obtain a histogram of luminance, the obtained R, G and B component values are converted into Y component values (luminance component values) by using a well-known conversion equation and the obtained Y component values are plotted on a graph with a horizontal axis for a value of the Y component value (also referred to as a gradation value) and a vertical axis for appearance frequency. In order to obtain average luminance, a total value of the Y component values obtained in the pixel data is divided by the number of pixel data, and in order to obtain the minimum luminance and the maximum luminance, the minimum luminance value and the maximum luminance value in the luminance histogram are specified.

In order to specify the hue, saturation and brightness of representative color, the R, G and B values of the image data or the image data after thinning may be converted into HSV values, a histogram with a vertical axis for appearance frequency and a horizontal axis for a value of each component may be created for each of the H (hue), S (saturation) and V (brightness) obtained after the conversion, and the hue value, saturation value and brightness value having the highest frequency may be specified as the hue, saturation and brightness of representative color. A detailed description of the RGB color space-HSV color space conversion process will be omitted because it is well known.

Regarding the edge quantity and the edge direction, for example, a well-known 3×3 Prewitt operator and a 5×5 Prewitt operator are used to calculate the edge quantity and the edge angle.

The area of a main subject (face area) can be set by grouping adjacent pixels of which pixel values, for example, three R, G and B component values approximate to each other, or adjacent pixels belonging to a predetermined hue (generally, skin color) range among pixels constituting the image. In addition, by setting an X-Y coordinate axis in the whole area of the image, the position and the size of the face area in the image and the positions of organs such as eyes, a mouth and a nose in the face area can be specified by coordinate positions. Under the above premise, in the case of face size, the width and the height of the set face area are obtained by an inter-coordinate distance. In the case of face direction, an inter-coordinate distance between the eyes and the mouth, an inter-coordinate distance between the eyes and the sizes of the mouth and the eyes in the face area facing the front side are provided in advance as reference values. When an inter-coordinate distance between the eyes and the mouth in the set face area is shorter than the reference value and the size of the mouth is larger than the reference value, it can be judged that the face in the image faces the upper side, and when an inter-coordinate distance between the eyes and the mouth in the set face area is the same as the reference value, an inter-coordinate distance between the eyes is smaller than the reference value and a size of the right eye is larger than the reference value, it can be judged that the face in the image faces the left side. Accordingly, swing angles of the face in vertical and horizontal directions can be specified by associating in advance angles of the face with differences between the reference values and the inter-coordinate distance between the eyes and the mouth, the inter-coordinate distance between the eyes and the sizes of the mouth and the eyes in the set face area. The face shape and the facial expression of a face can be specified on the basis of coordinate values of the outline of the face and the organs. That is, coordinate values of the organs may be associated in advance with facial expressions showing feelings of delight, anger, sorrow and pleasure. The face texture is obtained by performing a frequency analysis on the set face area. The frequency analysis with respect to the set face area is carried out by obtaining frequencies of pixel data constituting the set face area by using a two-dimensional Fourier transformation formula. In general, when a large quantity of low-frequency components is included in the obtained frequency components, the image is a smooth image, and when a large quantity of high-frequency components is included, the image is not a smooth image.

When the plural kinds of feature quantities are acquired from the image data by the feature quantity acquisition module SM22, the identifier retrieval module SM23 retrieves from the feature quantity-identifier database DB3 identifiers coincident with the acquired feature quantities. (Step S104). In greater detail, a similarity degree is calculated by using values of the various feature quantities acquired from the image data and values of feature quantities associated with each identifier in the feature quantity-identifier database DB3, and when the calculated similarity degree is in a predetermined range, it is judged that the values of the feature quantities acquired from the image data are coincident with the values of the feature quantities associated with the identifier. In determining a similarity degree between the feature quantities, for example, a method of calculating a distance such as a Euclidean distance or a Mahalanobis' generalized distance is applied. In greater detail, the judgment is made by using distances between the values of the feature quantities of the image data and the values of the feature quantities associated with the identifier, that is, distances between multidimensional vectors shown by the values of the feature quantities of the image data and the values of the feature quantities associated with the identifier. It is judged that the shorter the obtained distance, the more the values of the feature quantities of the image data and the values of the feature quantities associated with the identifier are similar to each other. Otherwise, the judgment may be made by obtaining an inner product of a multidimensional vector with the values of the feature quantities of the image data as components and a multidimensional vector with the values of the feature quantities associated with the identifier as components. In this case, since a difference between cosine components of the multidimensional vectors is obtained, it can be judged that the closer to 1 the obtained value of the inner product (the closer to 0 the angle between the multidimensional vectors), the higher the similarity degree.

When an Euclidean distance is used, a similarity degree can be calculated by the following Formulas 1 and 2.

$$\begin{matrix}SIMILARITY DEGREE = \sqrt{{\sum }_{i = 1}^{n} {ki ( xi - yi )}^{2}} & [ Formula 1 ] \\ SIMILARITY DEGREE = \sqrt{k 1 {( SHAPE OF FACE )}^{2} + k 2 {( FACIAL EXPRESSION OF FACE )}^{2} + k 3 {( SIZE OF FACE )}^{2}} & [ Formula 2 ]\end{matrix}$$

In Formula 1, the symbol xi is a value of the feature quantity of the image data, the symbol yi is a value of the feature quantity associated with the identifier and the symbol ki is a weighting coefficient (an arbitrary value which is not equal to zero). For the sake of easier understanding in Formula 2, it is specified that a total value (distance) of differences, each of which is obtained for each feature quantity, is used as a similarity degree. In determining a similarity degree by using a distance, the closer to 0 the calculation result, the more the image data and the identifier are similar to each other. Accordingly, a large coefficient may be applied to a feature quantity whose importance is high to increase sensitivity for the feature quantity, thereby narrowing the number of retrieval results. In the calculation of a similarity degree, the similarity degree may be calculated for each feature quantity by using the mathematical expression shown in Formula 1 and the simple sum of the calculated similarity degrees may be used.

When an inner product is used, the similarity degree can be calculated by using the following Formula 3. The coefficient in Formula 3 is applied to each component of a multidimensional vector.

$$SIMILARITY DEGREE = cos θ = \frac{{{g}^{->}}_{R} \cdot {{g}^{->}}_{S}}{\vert {{g}^{->}}_{R} \vert \vert {{g}^{->}}_{S} \vert} = \frac{{k}_{1} {g}_{R 1} {g}_{S 1} + {k}_{2} {g}_{R 2} {g}_{S 2} + … {k}_{n} {g}_{Rn} {g}_{Sn}}{\sqrt{{k}_{1} {g}_{R 1} {g}_{S 1} + {k}_{2} {g}_{R 2} {g}_{S 2} + … {k}_{n} {g}_{Rn} {g}_{Sn}}} \\ {{g}^{->}}_{R} : MULTIDIMENSIONAL VECTOR OF FEATURE QUANTITIES OF IMAGE DATA \\ {{g}^{->}}_{S} : MULTIDIMENSIONAL VECTOR OF FEATURE QUANTITIES ASSOCIATED WITH IDENTIFIER \qquad [ Formula 3 ]$$

Also, when using an inner product as a similarity degree, the closer the angle between multidimensional vectors is to 0, the more the image data and the identifier are similar to each other. Accordingly, the feature quantities having values which are the same or approximate to each other in a plurality of the image data may be significantly weighted so as to increase sensitivity for feature quantities with a high importance, and thus the retrieval results can be carefully selected and retrieval accuracy can be improved.

The identifier retrieval module SM23 temporarily stores the acquired identifiers and the similarity degrees together in the memory 202. The image database establishment module SM24 establishes or updates the image database DB1 by storing an identifier with the highest similarity degree (that is, the value of the obtained similarity degree is the smallest) or an identifier, the obtained similarity degree of which is equal to or lower than a predetermined value in association with the image data in the storage device 103 by using the identifiers and the similarity degrees stored in the memory 202 (Step S106). In the example of the image database DB1 shown in FIG. 3, only one identifier is given to the image data. However, when image feature quantities correspond to a unique keyword (keyword with high retrieval frequency) such as “smiling face”, image data is associated with an identifier relating to the smiling face in addition to an identifier relating to a face. Further, as described above, a plurality of identifiers may be given together with similarity degrees. Also in this case, a plurality of the same identifiers do not exist and an identifier is unique in the relationship with feature quantities (keyword group). In general, the higher the similarity degree which is obtained by the above-described method, the smaller the value of the similarity degree, and it is difficult to intuitively judge a level of the similarity degree. Accordingly, in the image database DB1 shown in FIG. 3, the relevance degrees shown by percentages are associated in place of the similarity degrees for the sake of easier description, but it is obvious that the values of the similarity degrees may be associated. In this regard, the values of the similarity degrees may be associated and converted into indices such as relevance degrees when being displayed. The relevance degrees are assigned in a manner such that a value of 100% to 50% is assigned to a range generally indicating a high similarity degree by a linear function (when the similarity degree is zero, the value is 100%), and a value less than 50% is discretely assigned to a similarity degree which is judged to be low in accordance with a predetermined rule. Alternatively, a calculation process may be carried out so that the reciprocal of an obtained similarity degree is subjected to a normalization process or the like and thus a large value is taken when a value of the similarity degree is small (the similarity degree is high).

The image database creation device 20 repeatedly executes Steps S100 to S106 until there are no image data as process targets (No: Step S108). When there are no target image data (Step S108: Yes), this process routine ends.

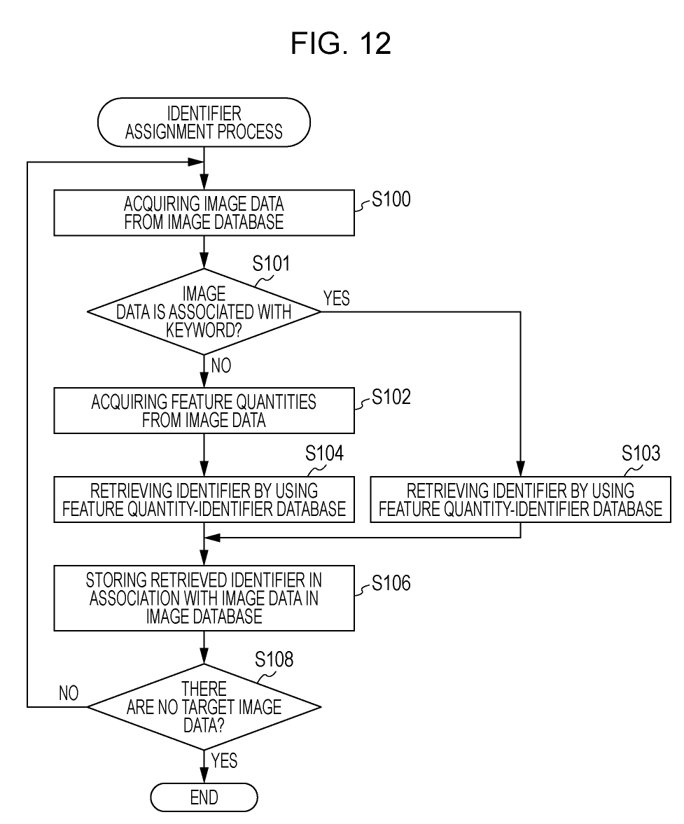

FIG. 12 is a flowchart illustrating a process routine of another identifier assignment process which is executed by the image database creation device according to this embodiment. In this example, the case in which a keyword is given to image data in advance will be described. The process steps which are the same as those in the identifier assignment process shown in FIG. 11 will be denoted by the same symbols, and detailed descriptions thereof will be omitted.

When this process routine is started, the image data acquisition module SM21 acquires image data from the storage device 103 (Step S100). When the image is acquired by the image data acquisition module SM21, the keyword acquisition module SM25 for identifier retrieval determines whether the image data is associated with a keyword (Step S101). The keyword may be previously associated as metadata with the acquired image data or may be input as a keyword for the acquired image data by a user via the input device 22.

When no keyword associated with the image is acquired by the keyword acquisition module SM25 for identifier retrieval (Step S101: No), the image database creation device 20 executes Steps S102 to S108.

When a keyword associated with the image is acquired by the keyword acquisition module SM25 for identifier retrieval (Step S101: Yes), the identifier retrieval module SM23 retrieves from the feature quantity-identifier database DB3 a corresponding identifier by using the acquired keyword (Step S103). As described above, in the feature quantity-identifier database DB3, the same keyword groups as those in the keyword-identifier database DB2 are associated with identifiers, respectively, and thus by using the acquired keyword, a corresponding identifier can be retrieved. Since the keyword group which is associated with an identifier in the feature quantity-identifier database DB3 hierarchically includes a plurality of keywords, several identifiers which are coincident with the acquired keyword are easily retrieved. In addition, when the keyword acquisition module SM25 for identifier retrieval can execute a morphological analysis and a process of leaving a space between words with respect to the acquired keyword, nouns which are obtained by the process of leaving a space between words are used as keywords and retrieval accuracy of the identifier is improved. In general, the identifier which is retrieved when a keyword is used is singular. However, in the case of a high-frequency keyword, for example, “smiling face”, an identifier of the “smiling face” is separately provided in addition to the identifier of “face”, and thus a plurality of identifiers are retrieved in some cases.

When the identifier is retrieved, the image database establishment module SM24 establishes or updates the image database by associating the acquired identifier with the image data (Step S106). The image database creation device 20 executes the process of Step S108 and thus this process routine ends. In this process routine, since it is unnecessary to consider feature quantities of the image, the keyword-identifier database DB2 of the image server 10 may be used in place of the feature quantity-identifier database DB3 in Step S103.

In the above-described process routine, when a keyword is acquired, image feature quantities are not considered at all. However, image feature quantities may be used to decide an identifier even though a keyword is acquired. In this case, a high similarity degree may be given to an identifier decided on the basis of a keyword and a similarity degree, which is lower than that given to the identifier decided on the basis of the keyword, may be given to an identifier decided on the basis of image feature quantities. That is, this is because it is thought that the keyword which is given to image data in advance indicates features of the image data.

### Image Retrieval Process:

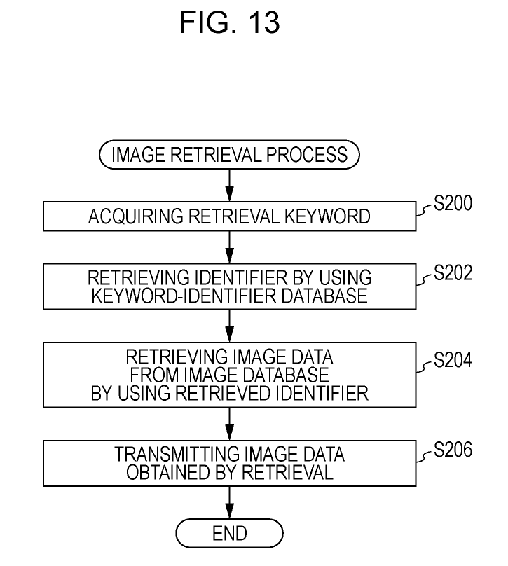

FIG. 13 is a flowchart illustrating a process routine which is executed in the image retrieval process according to this embodiment. The image retrieval process is executed in the image server 10 by receiving a retrieval request from a retrieval terminal device such as the printer 30. When this process routine is started, the retrieval keyword acquisition module SM11 acquires a retrieval keyword (Step S200). The acquisition of the retrieval keyword is realized by acquiring a keyword input via the input operating section 32 of the printer 30 or a keyword described in metadata which is associated with the image data transmitted from the printer 30.

When the retrieval keyword is acquired, the identifier acquisition module SM12 retrieves an identifier corresponding to the acquired retrieval keyword by using the keyword-identifier database DB2 (Step S202). In greater detail, by specifying a keyword group including a keyword which is coincident with the retrieval keyword among the keyword groups included in the keyword-identifier database DB2, an identifier which is associated with the keyword group is retrieved. The identifier acquisition module SM12 may execute a morphological analysis and a process of leaving a space between words. In this case, even when a keyword other than a simple noun is input as the retrieval keyword, a noun obtained by the process of leaving a space between words is used as the keyword and thus the retrieval of an identifier can be executed. Moreover, it is desirable that the keyword-identifier database DB2 and the feature quantity-identifier database DB3 are regularly subjected to a synchronous process. That is, this is because when the correspondence relationship between identifiers and keywords in the keyword-identifier database DB2 and the correspondence relationship between identifiers and keywords in the feature quantity-identifier database DB3 do not correspond to each other, a proper identifier cannot be retrieved on the basis of a keyword, and as a result, a decrease in image retrieval accuracy is caused.

When the identifier is retrieved, the image data retrieval module SM13 retrieves image data from the image database DB1 by using the retrieved identifier (Step S204). That is, in this embodiment, when image data is retrieved from the image database DB1, the retrieval of image data is executed by using the retrieved identifier without the similarity degree determination using feature quantities of the image data. In addition, the retrieved image data is associated with a similarity degree with respect to the identifier. Accordingly, image data can be rapidly retrieved from the image database DB1 and a similarity degree between the detected image data and the keyword can be acquired.

The image data transmission module SM14 transmits the retrieved image data to the printer 30 as a transmission source of the image data retrieval request (Step S206) and this process routine ends. Specifying the printer 30 as a transmission source can be carried out by using, for example, a transmission source address (IP address, MAC address) which is included in a header of the image retrieval request transmitted from the printer 30. In this embodiment, the communication between the devices which is carried out via a network is carried out in accordance with a well-known network protocol.

### Image Retrieval Request Process:

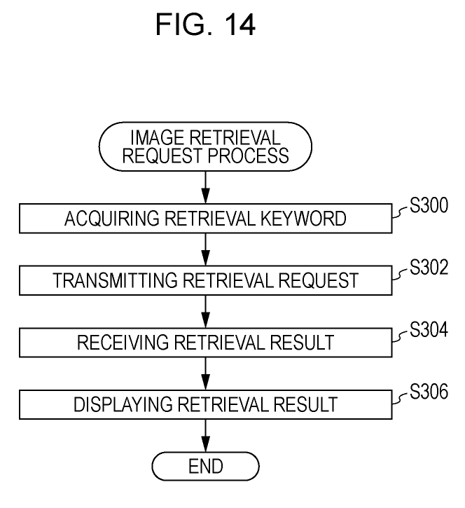

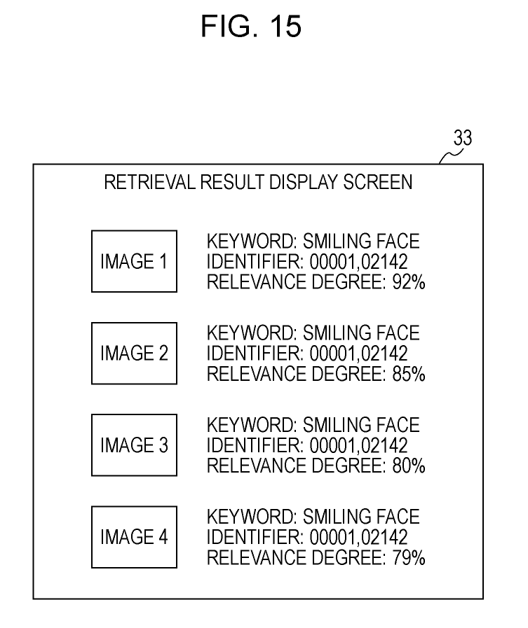

FIG. 14 is a flowchart illustrating a process routine which is executed in the image retrieval request process according to this embodiment. FIG. 15 is an explanatory diagram illustrating an example of an image retrieval result screen which is displayed in the printer according to this embodiment. This process routine is executed by the printer 30 as an image retrieval terminal. When this process routine is started, the keyword acquisition module CM11 of the printer 30 acquires a keyword (Step S300). In greater detail, the above step is executed by extracting a keyword input by a user via the input operating section 32 or a keyword described in metadata which is associated in advance with image data as a retrieval source.

When the keyword is acquired, the retrieval request transmission module CM12 transmits a retrieval request to the image server 10 (Step S302). In greater detail, a retrieval request data string including a keyword and a retrieval request command is transmitted to the image server 10 via the exterior I/O interface 35 and the network NE. The retrieval result reception module CM13 acquires at least one image data as a retrieval result received from the image server 10 (Step 5304) and displays a plurality of images on the display section 33 by using the acquired image data (Step S306), and this process routine ends. When a plurality of images are displayed on the display section 33, as shown in FIG. 15, relevance degrees (or similarity degrees) as indices each showing a relevance degree between each image and identifiers (keyword) may be displayed on the display section 33. In the example of FIG. 15, “smiling face” is used as the keyword, and two identifiers “00001” and “02142” which are assigned to the “smiling face” and the relevance degrees based on the similarity degrees between the image data and the “smiling face” as the keyword or the identifiers “00001” and “02142” are displayed. As in the example shown in FIG. 15, when a plurality of identifiers are assigned to a keyword, a relevance degree which is calculated on the basis of a high similarity degree, a low similarity degree or an average value of similarity degrees among the associated similarity degrees is displayed. By displaying the relevance degrees together with the retrieved images on the display section 33, a user can determine whether the previous keyword is proper as a retrieval keyword. When the user is dissatisfied with the retrieval result, the retrieval can be carried out once again by changing the keyword. The retrieval result reception module CM13 may include a function of a retrieval result display control module or a separate retrieval result display control module may be provided.

According to the image database creation device, the image database creation method, the image server, the image retrieval method, the printer (image retrieval terminal device), the image retrieval system according to the above-described embodiment, the image database DB1 stores image data in association with identifiers and the image data can be retrieved on the basis of the identifier. That is, when an image is retrieved, it is unnecessary to extract feature quantities from retrieval target image data which have been used and retrieved image data and to execute the calculation of a similarity degree by using the feature quantities of both the image data. In the feature quantity-identifier database DB3 which is used in creating the image database DB1, a plurality of feature quantities are associated (a number of image data are associated) with an identifier, and thus a larger quantity of image data can be rapidly retrieved with high accuracy as compared to a comparing process of the conventional retrieval target image data and the retrieved image data.

In this embodiment, when an image is retrieved, an identifier is retrieved in advance on the basis of a keyword and image data can be retrieved by using the retrieved identifier. Accordingly, retrieval speed and retrieval accuracy of the image data can be improved. That is, when an image is retrieved, it is unnecessary to extract image feature quantities which have been used and to execute the calculation of a similarity degree. In addition, since an identifier can be associated with a plurality of image data conceptually relating to each other, the retrieval of image data can be rapidly executed with high accuracy.

In this embodiment, in the image database DB1 which is created by the image database creation device 20, similarity degrees of image data with respect to identifiers (keywords) are stored in addition to the identifiers and thus it is possible to sort out the priorities of retrieval results even when retrieving an image by using an identifier. Moreover, it is possible to show a user a relevance degree between the keyword used in the retrieval and the image obtained by the retrieval and the user can determine whether the used keyword is a proper keyword on the basis of a numerical value.

In this embodiment, when the image database DB1 is created, plural kinds of feature quantities are associated with an identifier in the feature quantity-identifier database DB3 which is used by the image database creation device 20. Accordingly, the image database DB1 sufficiently considering (including) keywords (keyword groups) which are associated with identifiers can be created. As a result, the image database DB1 in which a plurality of image data conceptually relating to each other are associated with an identifier can be obtained and the accuracy of image data retrieval using the image database DB1 can be improved. In addition, in this embodiment, since a unique keyword such as “smiling face” having high retrieval frequency is associated with a unique identifier in addition to an identifier for a keyword group of “face”, image data corresponding to a keyword having high retrieval frequency can be rapidly retrieved.

Further, in this embodiment, a database in which a keyword group including a plurality of hierarchical keywords is associated with an identifier is used as the keyword-identifier database DB2 which is used in retrieving an image. Accordingly, even when fluctuation of expression or a synonym exists in a keyword which is input by a user, the image server 10 does not perform a retrieval process of a synonym database considering synonyms, but can retrieve with high accuracy a coincident keyword from the keyword-identifier database DB2. That is, since hierarchical keywords from broader concepts to narrower concepts are provided as keyword groups, an abstract keyword can be handled, and since synonyms and a plurality of relating keywords are provided, different expressions of a keyword for different users can be handled.

Also in the case in which a new candidate word is generated as a keyword, the above case can be handled by updating a list of corresponding keyword groups (that is, adding the word to the corresponding keyword group) and the maintenance of the keyword-identifier database DB2 and the feature quantity-identifier database DB3 can be easily carried out without the need to newly give an identifier or change an identifier. Further, in general, unique keywords are used in different databases. According to this embodiment, even when these different databases are integrated with each other, unique keywords are maintained in the databases and a single identifier can be associated therewith. Without requiring operations such as changing or updating keywords, the databases can be integrated. In addition, also in the printer 30 as an image retrieval terminal device, a keyword may be transmitted alone to the image server 10 without adding additional information such as synonyms to the keyword. Accordingly, a decrease in retrieval accuracy resulting from the fluctuation of keywords can be prevented and suppressed and a prolonged image retrieval time resulting from the fluctuation of keywords can be reduced.

### Modified Examples

(1) In the above-described embodiment, the feature quantity-identifier database DB3 and the keyword-identifier database DB2 are separately provided. However, these may be provided as a common database in the image server 10. That is, as shown in FIG. 7, one database may be used in which identifiers, image feature quantities and keywords (keyword groups) are associated with each other. In this case, synchronous processing of contents between the feature quantity-identifier database DB3 and the keyword-identifier database DB2 is not required and the configuration of the image database creation device 20 can be simplified.

(2) In the above-described embodiment, the description was made by exemplifying the printer 30 as an image retrieval terminal device. However, the personal computer 40 can also be used in the same manner. The personal computer 40 includes the display 41 and the input device (keyboard, mouse) 42.

(3) In the above-described embodiment, the example has been described in which a retrieval keyword is transmitted to the image server 10 from the printer 30 as an image retrieval terminal device. However, in place of the keyword, image data as a retrieval target may be transmitted to the image server 10 from the printer 30. In this case, the image server 10 may acquire plural kinds of feature quantities of the received image data and may retrieve an identifier for retrieval by using a feature quantity-identifier database. As the feature quantity-identifier database, the above-described feature quantity-identifier database DB3 may be used. Also in this case, the image database DB1 in which image data and identifiers are associated with each other can be used and image retrieval speed and image retrieval accuracy can be improved.

(4) In the above-described embodiment, a server computer retrieving an image database in response to a request from a client has been exemplified as the image server 10 to describe the image retrieval process. However, the image retrieval process may be executed in the printer 30 or the personal computer 40. For example, the above-described image data retrieval operation may be executed in a local image database which is stored in the storage device of the personal computer 40. When the printer 30 is provided with a large-capacity storage device, the above-described image retrieval method may be applied to the local retrieval of image data in the printer 30. That is, the image server may be realized as a part of a function or a computer program of a stand-alone personal computer or printer which is not connected to a network or a computer-readable medium in which a computer program is stored. In this case, convenience in the retrieval of image data in a personal computer, that is, an improvement in retrieval speed, an improvement in retrieval accuracy and ease of retrieval can be realized. As a computer-readable medium, various recording mediums can be used such as CD, DVD, hard disk drive and flash memory.

(5) In the above-described embodiment, the image retrieval has been described as an example, but the embodiment can also be applied to other content, such as videos, music, games and e-books. Feature quantities of videos can be acquired in the same manner as in the case of images and a keyword can be acquired by being extracted from metadata. Feature quantities of music can be acquired by applying a key detection technique and a keyword can be acquired by being extracted from metadata. In the case of games, a keyword can be acquired on the basis of metadata or the like, and in the case of e-books, feature quantities can be acquired by analyzing frequently-appearing words. That is, in this embodiment, as shown in FIG. 12, a database can be created in which the retrieval can be carried out by an identifier when keywords are associated with content.

(6) In the above-described embodiment, retrieval results received from the image server 10 are subjected to a process for display in the printer 30 and displayed on the display section 33. However, retrieval result data for display may be created in the image server 10 and transmitted to the printer 30. As a method for displaying the retrieval result data from the image server 10 in the printer 30, for example, there is a method including installing a Web server function in the image server 10 and installing a Web browser in the printer 30. According to this method, the HTML database display can be carried out in accordance with a general-purpose HTTP protocol.

Although the invention has been described on the basis of the embodiments and the modified examples as described above, the above-described embodiment is provided to make the understanding of the invention easier and the invention is not limited thereto. Changes and improvements can be made without departing from the spirit and claims of the invention and the invention includes equivalents thereof.

What is claimed is:

1. A device comprising:
an image receiver which receives an image; and
a storage controller which stores the image in association with an identifier corresponding to a feature quantity of the image by using a previously prepared relationship between a feature quantity and an identifier.

2. The device according to claim 1,
wherein the storage controller stores a similarity degree between the identifier and the image in association with the image.

3. The device according to claim 2, further comprising:
a keyword receiver which receives a keyword,
wherein when the image receiver receives the image and the keyword receiver receives a keyword, the storage controller stores the image in association with an identifier corresponding to the image by using a previously prepared relationship between a plurality of feature quantities and an identifier and a relationship between a keyword and an identifier, and
wherein a similarity degree between the identifier and the image, which are associated with each other by using the relationship between a plurality of feature quantities and an identifier, is lower than a similarity degree between the identifier and the image, which are associated with each other by using the relationship between a keyword and an identifier.

4. The device according to claim 3,
wherein the keyword is associated with the image.

5. The device according to claim 1,
wherein the device retrieves a certain image from a plurality of stored image groups.

6. A method of causing a computer to execute:
receiving an image; and
storing the image in association with an identifier corresponding to a plurality of feature quantities of the image by using a previously prepared relationship between a plurality of feature quantities and an identifier.

7. A storage medium which stores a program that causes a computer to execute:
receiving an image; and
storing the image in association with an identifier corresponding to a plurality of feature quantities of the image by using a previously prepared relationship between a plurality of feature quantities and an identifier.
